(19) United States
(12) Patent Application Publication
(10) Pub. No.: US 2008/0252223 A1
(43) Pub. Date: Oct. 16, 2008

(54) Organic EL Display Device

(76) Inventors: Hironori Toyoda, Mobara (JP); Naruhiko Kasai, Yokohama (JP); Hajime Murakami, Shinjuku (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/047,337

(22) Filed: Mar. 13, 2008

(30) Foreign Application Priority Data
Mar. 16, 2007 (JP) 2007-068695

(51) Int. Cl. G09G 3/30

(52) U.S. Cl. 315/169.3

(57) ABSTRACT

The present invention provides an organic EL display device with high detection accuracy which can enhance both of light emission efficiency and light reception efficiency. In an organic EL display device which includes organic thin film elements, a power source line is connected to the organic thin film elements via drive TFTs, a signal line is connected to a gate of the drive TFT to supply a potential corresponding to a gray scale signal, a switch is provided for connecting the signal line and the organic thin film element, and the switch is controlled to allow an electric current which is obtained by photoelectric conversion with the organic thin film element to flow in the signal line and the organic thin film element during a period in which a gray scale signal is not applied to the signal line.

### CROSS-REFERENCE TO RELATED APPLICATIONS

The disclosure of Japanese Patent Application No. 2007-068695 filed on 2007/Mar./16 (yyyy/mm/dd) including the claims, the specification, the drawings and the abstract is incorporated herein by reference in its entirety.

### BACKGROUND OF THE INVENTION

1. Field of the Invention

The present invention relates to an organic EL display device including light receiving elements, and more particularly to an organic EL display device in which a light receiving element is constituted of an organic thin film element.

2. Description of the Related Art

Patent document 1 (JP-A-11-75115) discloses a conventional technique relating to an organic EL display device in which a light receiving element is constituted of an organic thin film element.

The patent document 1 discloses the structure in which first organic thin film elements are vertically arranged parallel to each other in the planar direction, a second organic thin film element having the same stacked structure as the first organic thin film element is arranged between the first organic thin film elements, and the first organic thin film elements and the second organic thin film element are respectively connected to signal lines different from each other.

The display device described in patent document 1 is configured to be controlled in three modes, that is, a mode which uses both of the first organic thin film elements and the second organic thin film element as a light emitting element, a mode which uses one of the first organic thin film elements and the second organic thin film element as a light receiving element and uses another as a light emitting element, and a mode which uses both of the first organic thin film elements and the second organic thin film element as a light receiving element.

### SUMMARY OF THE INVENTION

In the patent document 1, a pixel circuit is configured such that a so-called drive TFT is arranged between a power source line and an organic thin film element. By outputting an electromotive force generated due to the photoelectric conversion of the organic thin film element to the outside of a display region using the power source line, a magnitude of the electromotive force is detected outside the display region. When the power source line is used as a detection path for detecting the electromotive force as described above, a load capacitance is increased thus lowering the detection accuracy.

Although the patent document 1 also discloses the structure in which the power source line also functions as a detection signal line, such structure makes a light emission control difficult.

Further, it is substantially impossible to design the structure which can suppress a voltage drop of the power source line by allowing the power source line to be used in common by a plurality of lines. This is because that, when the power source line is used in common by all lines, the parasitic capacitance corresponding to all lines, that is, the parasitic capacitance several hundred times as large as the parasitic capacitance corresponding to 1 line is generated.

Accordingly, the first object of the present invention is to provide an organic EL display device which can increase external light detection accuracy.

Further, in patent document 1, the first organic thin film element and the second organic thin film element have the same layered structure. In using the first organic thin film element as the light emitting element and the second organic thin film element as the light receiving element, materials and layer thicknesses preferable to the respective elements completely differ from each other. Accordingly, in case of patent document 1 where the first organic thin film element and the second organic thin film element have the same layered structure, in display, there exists the possibility that either one of the light emission characteristic and the light reception characteristic is sacrificed. For example, when the light emission characteristic is sacrificed as a result of enhancing the light reception characteristic, a lifetime of the organic EL display device is shortened.

It is another object of the present invention to provide an organic EL display device which can realize both of the enhancement of the light emission characteristic and the light reception characteristic.

As means for achieving the above-mentioned first object, the present invention provides following modes.

### (First Means)

In an organic EL display device which includes a first switch for controlling a quantity of electric current which flows between a power source line and an organic thin film element in response to a gray scale signal from a signal line, the organic EL display device includes a second switch which is controlled to connect the signal line and the organic thin film element during a period in which the gray scale signal is not supplied to the signal line.

### (Second Means)

In an organic EL display device which includes a switch for controlling a quantity of electric current which flows between a power source line and an organic thin film element in response to a gray scale signal from a signal line, the gray scale signal is supplied to the signal line from a drive circuit during a first period, and a voltage corresponding to an external light which is generated by the organic thin film element is supplied to the signal line during a second period different from the first period.

As means for achieving the above-mentioned another object, the present invention provides following modes.

### (Third Means)

The layered structure of an organic layer which constitutes a light emitting element and the layered structure of an organic layer which constitutes a light receiving element are made different from each other.

### (Fourth Means)

The light emitting element and the light receiving element include an organic layer, and the organic layer of the light receiving element is made of a material which does not emit light with a natural light.

By adopting either one of the third means and the fourth means, it is possible to provide an organic EL display device which exhibits both of high light emitting efficiency and high light receiving efficiency.

Not only by simply making the layered structure of the light emitting element and the layered structure of the light receiving element different from each other but also by using a portion of the organic layer which constitutes the light emitting element as a portion of the light receiving element, the light receiving element can be simultaneously formed in a portion of the manufacturing process of the light emitting element thus realizing the efficient manufacture of the organic EL display device.

According to the present invention, it is possible to provide the organic EL display device with high detection accuracy.

### BRIEF DESCRIPTION OF THE DRAWINGS

FIG. 1 is a schematic view of energy levels of organic thin film elements at a dark place;

FIG. 2 is a view showing behaviors of holes 206 and electrons 207 when an external light (a light radiated from the outside of the substrate, that is, from the outside of an organic EL display device) is radiated to the organic thin film element;

FIG. 3 is a view showing a detection result of a current/voltage characteristic of the organic thin film element;

FIG. 4 is a view showing the basic constitution of a display panel of an embodiment 1;

FIG. 5 is a view showing the further detailed system constitution of the display panel shown in FIG. 4;

FIG. 6 is a constitutional view of a panel system showing a signal path between a display element and another system in a display mode;

FIG. 7 is a constitutional view of a panel system showing a signal path between a display element and another system in a detection mode;

FIG. 8 is a constitutional view of a panel system which also includes a reference element 10;

FIG. 9 is a constitutional example of a detection circuit 5;

FIG. 10 is a detection timing chart;

FIG. 11 is a flowchart of a detection flow of a display control part 3-1 and a detection circuit 5;

FIG. 12 is a view showing one constitutional example relating to the reference element, the detection line and the display element;

FIG. 13 is a view showing one constitutional example relating to the reference element, the detection line and the display element;

FIG. 14 is a view showing one constitutional example relating to the reference element, the detection line and the display element;

FIG. 15 is a view showing one constitutional example relating to the reference element, the detection line and the display element;

FIG. 16 is a basic constitutional view of a display panel in which one pixel is formed by using a light receiving element and a light emitting element as a set;

FIG. 17 is a view showing one example of the system constitution of the display panel shown in FIG. 16;

FIG. 18 is a view showing a constitutional example of a periphery of a signal line DATA;

FIG. 19 is a view showing a constitutional example of the periphery of the signal line DATA;

FIG. 20 is a view showing the layered structure of the organic thin film element;

FIG. 21 is a view showing an equivalent circuit of a pixel circuit of a display pixel;

FIG. 22 is a view showing the basic constitution of the display panel; and

FIG. 23 is a view showing the constitution of the pixel circuit controlling a light emitting of the display element 11.

### DETAILED DESCRIPTION OF THE INVENTION

First of all, a light detection mechanism used in the present invention is explained. Although the explanation is made hereinafter on the premise of an organic thin film element of a so-called bottom-emission-type or top-cathode-type active organic EL display device, the present invention is not limited to such an organic thin film element.

The structure which becomes a premise of this embodiment includes a pixel electrode (an anode 204) made of ITO which is connected to an active element on a substrate. Further, on the anode 204, a hole injection layer 201, a light emitting layer 202, an electron transport layer 203, and an aluminum counter electrode (cathode 205) are sequentially stacked.

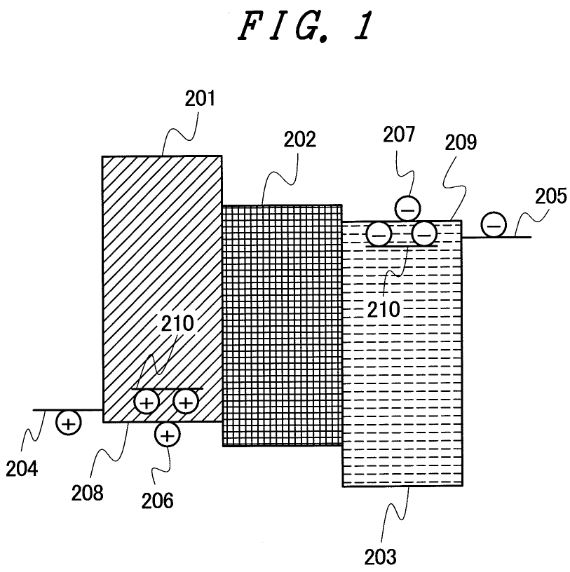

FIG. 1 is a schematic view showing an energy level of the organic thin film element in a dark place. By applying a voltage between the anode 204 and the cathode 205 of the organic thin film element, holes 206 are injected into the hole injection layer 201 from the anode 204, and electrons 207 are injected into the electron transport layer 203 from the cathode 205. The holes 206 are transported to the light emitting layer 202 through a highest occupied trajectory 208 of each layer, while the electrons 207 are transported to the light emitting layer 202 through a lowest empty trajectory 209 of each layer. In such a transport step, when a trap level 210 is present in the hole injection layer 201 and the electron transport layer 203, the holes 206 and the electrons 207 are trapped so that a quantity of electric current which flows in the whole element is lowered. Although the trap level 210 is generated, in general, due to impurities such as decomposed materials, a similar phenomenon can be observed by intentionally mixing trapping-property molecules in the organic layer.

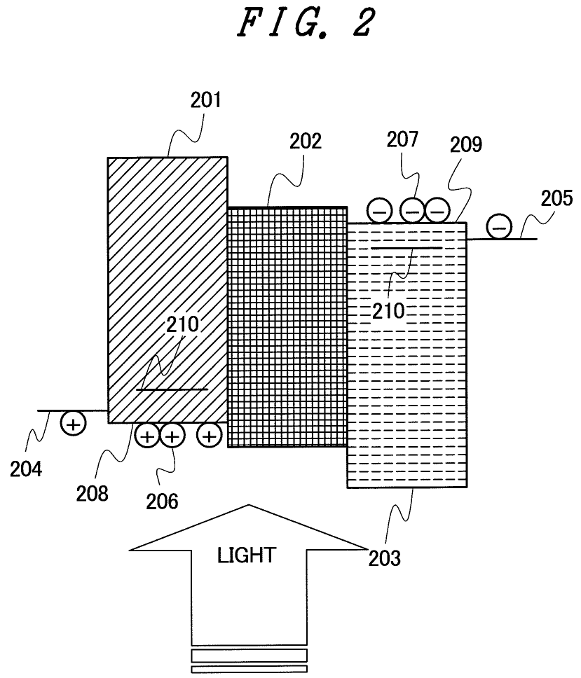

FIG. 2 shows behaviors of the holes 206 and the electrons 207 when an external light (a light radiated from the outside of the substrate, that is, from the outside of the organic EL display device) is radiated to the organic thin film element. When the external light is radiated to the organic thin film element, the holes 206 and the electrons 207 trapped at the trap level 210 respectively transit to the highest occupied trajectory 208 of the hole injection layer 201 and the lowest empty trajectory 209 of the electron transport layer 203. This is because that the holes 206 and the electrons 207 acquire, due to the radiation of the external light, the energy larger than the energy difference between the highest occupied trajectory 208 of the hole injection layer 201 and the trap level 210 or the energy difference between the lowest empty trajectory 209 of the electron transport layer 203 and the trap level 210.

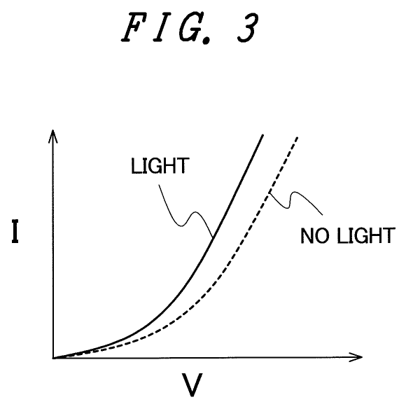

FIG. 3 shows a detection result of a current/voltage characteristic of the organic thin film element. The detection result indicated by “NO LIGHT” is a detection result (current/voltage characteristic) in a dark place. The detection result indicated by “LIGHT” is a detection result (current/voltage characteristic) when the external light is radiated. As can be understood from the drawing, when the external light is radiated, a large quantity of electric current is detected. That is, it is found that the organic thin film element of the organic EL display device possesses a photoelectric conversion function attributed to the external light.

In FIG. 1 to FIG. 3, the explanation is made by taking the case in which the hole injection layer 201, the light emitting layer 202, the electron transport layer 203, and the anode 205 are stacked on the anode 204 as an example. However, as a result of an experiment, it is found that the substantially equal advantageous effect is obtainable provided that the organic thin film element includes at least one layer which has the trap level 210 between the anode 204 and the cathode 205. Hereinafter, the explanation is made with respect to an embodiment of an organic EL display device exhibiting the detection accuracy higher than the detection accuracy of the display device disclosed in patent document 1 from such an experimental result.

Before explaining the embodiment 1, the basic constitution of the display panel applied to an active-matrix-type organic EL display device which becomes the premise of the embodiment 1 is explained.

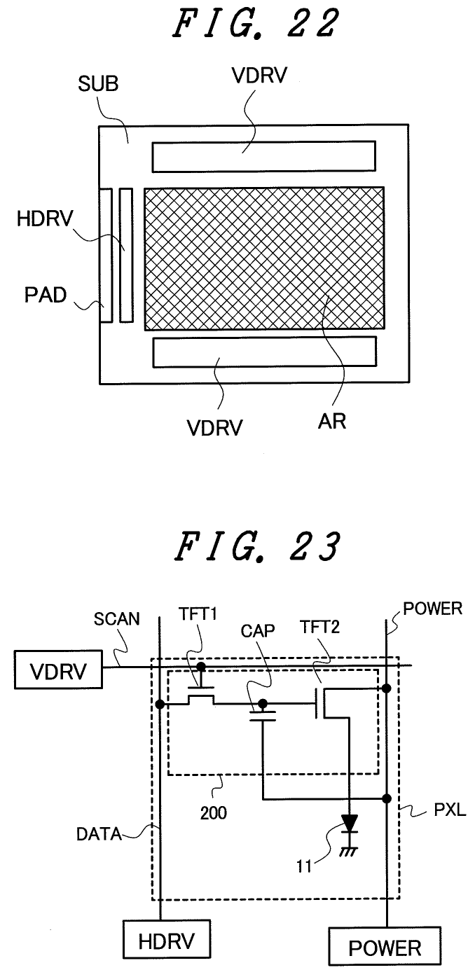

FIG. 22 shows the basic constitution of the display panel. On a glass substrate SUB, a signal line drive circuit HDRV, a scanning line drive circuit VDRV, an effective display region AR, and an external connection terminal PAD are formed.

The signal line drive circuit HDRV is constituted of a semiconductor IC chip referred to as a driver IC in general, and is mounted between the effective display region AR and the external connection terminal PAD arranged on one side of the glass substrate SUB1 by COG (Chip on Glass) mounting. The scanning line drive circuit VDRV is a circuit constituted of a low-temperature poly-silicon layer and metal lines, and is arranged on two sides of the glass substrate SUB1 which sandwich one side of the glass substrate SUB1 on which the signal line drive circuit HDRV is arranged. Display pixels PXL are arranged in the effective display region AR. Further, although a reference pixel is not shown in the drawing, the reference pixel is arranged in a light blocking region outside the effective display region AR.

FIG. 21 shows an equivalent circuit of the display pixel PXL. The pixel PXL includes a display element 11 which functions as a light emitting/receiving element, a signal line DATA to which a gray-scale signal or a detection voltage is supplied, a scanning line SCAN to which a control signal is supplied, a power source line POWER to which an electric current is supplied, a detection control line DET to which a control signal is supplied, a data latch switch TFT1 connected to the signal line DATA and one terminal of a capacitor CAP and controlled by the control signal of the scanning line SCAN, the capacitor CAP having one terminal thereof electrically connected to the data latch switch TFT1 and another terminal thereof connected to the power source line POWER, a drive switch TFT2 connected to one terminal of the capacitor CAP and controlled with a potential of the capacitor CAP, the display element 11 electrically connected to the power source line POWER via the drive switch TFT2, and a pixel detection switch TFT3 electrically connected between the display element 11 and the signal line DATA. The pixel circuit 2 is constituted of the data latch switch TFT1, the capacitor CAP, the drive switch TFT2, and the pixel detection switch TFT3. The data latch switch TFT1, the drive switch TFT2, and the pixel detection switch TFT3 are respectively formed of a thin film transistor made of low-temperature poly-silicon.

The pixel circuit 2 is driven as follows. In a display mode, the data latch switch TFT1 is turned on in response to a control signal supplied to the scanning line SCAN from the scanning line drive circuit VDRV, and fetches the gray-scale signal from the signal line DATA. The capacitor CAP holds a potential difference (the potential difference between a potential of the gray-scale signal and a potential of the power source line POWER) corresponding to the fetched gray-scale signal. The drive switch TFT2 is controlled to supply a quantity of electric current corresponding to a voltage including the holding potential difference to the display element 11 from the power source line POWER. Next, in a detection mode, a control signal is supplied to the detection control line DET connected to the control terminal of the pixel detection switch TFT3, and a voltage generated in the display element 11 is supplied to the signal line DATA at the timing that a gray-scale signal is not supplied to the signal line DATA. In the display mode, a potential of a display-use power source (voltage) 7 is supplied to the power source line POWER. In the detection mode, a detection-use power source (current) 6 is connected to the data line DATA.

As described above, in the display mode, in each pixel, the gray-scale signal is supplied to the signal line via the data latch switch TFT1 and the capacitor CAP for controlling the drive switch TFT2. Further, due to the control of the drive switch TFT2, a quantity of electric current corresponding to the gray-scale signal is supplied to the display element 11 from the power source line POWER.

Further, in the detection mode, the pixel detection switch TFT3 arranged between the signal line DATA and the power source line POWER is controlled to connect a line which electrically connects the power source line POWER and the display element 1 with the signal line DATA in a period that the gray-scale signal is not supplied to the signal line DATA. Accordingly, a voltage corresponding to an external light is outputted to the signal line DATA from the display element 11 via the pixel detection switch TFT3. Further, the detection circuit 5 is mounted on the driver IC and hence, the detection circuit 5 is connected to the signal line DATA and the signal line drive circuit HDRV using lines different from the signal line DATA and, further, the detection circuit 5 is connected to a terminal of the signal line drive circuit HDRV different from the terminal of the signal line drive circuit HDRV to which the signal line DATA is connected.

### EMBODIMENT 1

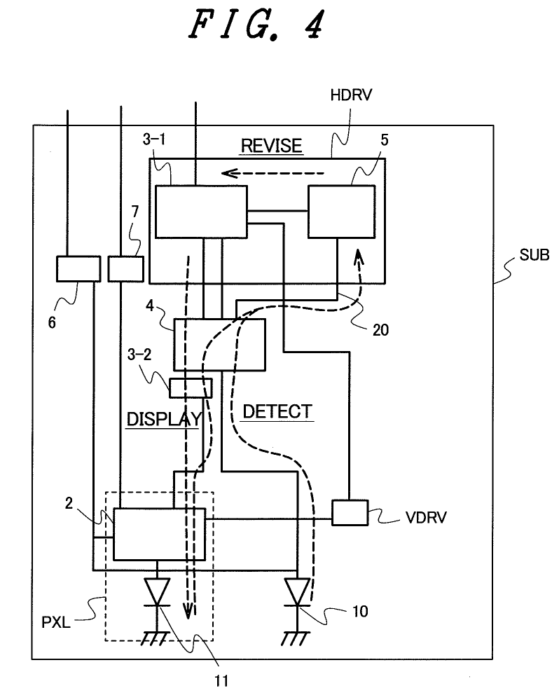

FIG. 4 shows the basic constitution of a display panel of the embodiment 1. The display panel of the embodiment 1 includes a pixel circuit 2, a display control part 3-1, a color selection circuit 3-2, a detection switch 4, the detection circuit 5, a detection-use power source 6, a display-use power source 7, a reference element 10, a display element 11, and the scanning line drive circuit VDRV.

The display control part 3-1, the detection circuit 5 and the detection-use power source 6 are incorporated in the signal line drive circuit HDRV shown in FIG. 22.

A first terminal of the signal line drive circuit HDRV is directly connected to the detection switch 4, and a second terminal which differs from the first terminal is connected to the detection switch 4 via the detection circuit 5.

The pixel circuit 2 is, as described above, connected to the signal line DATA, the scanning line SCAN, the power source line POWER, and the detection control line DET. The signal line DATA is connected to the first terminal of the signal line drive circuit HDRV and, further, is electrically connected to the display control part 3-1 in the driver IC.

An analog power source, a digital power source, a clock, and a video signal are inputted to the display control part 3-1 from the outside, and the display control part 3-1 outputs a gray-scale signal to the color selection circuit 3-2 via the signal line DATA in a display mode. Further, in a detection mode, when a correction signal is inputted to the display control part 3-1 from the detection circuit 5, the display control part 3-1 corrects a gray-scale signal in response to a correction signal after the detection of the correction signal. Further, by controlling the detection-use power source 6 and the detection switch 4, the display control part 3-1 controls the connection between the detection-use power source 6 and the power source line POWER.

The pixel circuit 2, the color selection circuit 3-2, the scanning line drive circuit VDRV, and the detection switch 4 are respectively constituted of a thin film transistor, a low-temperature poly-silicon line, a gate metal line, a source drain metal line, and an interlayer insulation film which are formed on the grass substrate SUB1.

The color selection circuit 3-2 is arranged between the effective display region AR and the signal line drive circuit HDRV shown in FIG. 22. The color selection circuit 3-2 selects the signal line DATA of any one of colors to which the gray scale signal supplied from the display control part 3-1 is supplied. The color selection circuit 3-2 selects the detection voltage of the signal line DATA of any one of pixels to be supplied to the detection circuit 5.

The detection switch 4 changes over the connection between the display control part 3-1 and the pixel circuit 2 and the connection between the detection circuit 5 and the pixel circuit 2. Such changeover is performed by the display control part 3-1.

The detection circuit 5 detects a magnitude of a voltage supplied to the detection circuit 5 due to the connection between the detection circuit 5 and the pixel circuit 2 by the detection switch 4, generates a correction signal based on the detection result, and supplies the correction signal to the display control part 3.

The detection-use power source 6 is a power source for supplying a drive current to the pixel circuit 2 at the time of detection, and the light-emitting-use power source 7 is a power source for supplying a drive current to the pixel circuit 2 at the time of light emission.

Next, the manner of operation of the display panel shown in FIG. 4 is explained. A path of a signal is roughly classified into three paths, that is, a display path DISPLAY, a detection path DETECT, and a correction path REVISE. These paths are sequentially changed with time. Here, in this specification, a behavior which reflects a light detection result in a display state based on an arbitrary mode is referred to as “correction”.

The display control part 3-1 outputs the gray-scale signal to the signal line DATA in a first display period during which display is performed. In parallel with such outputting of the gray-scale signal, the detection switch 4 is controlled to supply the gray-scale signal to the color selection circuit 3-2. Further, the color selection circuit 3-2 is controlled to supply the gray-scale signal to the desired signal line DATA. The display control part 3-1 controls the scanning line drive circuit VDRV so as to allow the scanning line drive circuit VDRV to transmit the control signal to the scanning line SCAN of a specified pixel and turns on the data latch switch TFT1 to allow the supply of the gray-scale signal to the pixel circuit 2 of the specified pixel. Here, the detection switch 4 cuts off the connection between the detection circuit 5 and the detection-use power source 6. The pixel circuit 2 performs a control such that a quantity of electric current which flows in the display element 11 via the power source line POWER from the display-use power source 7 assumes a quantity of electric current corresponding to the supplied gray-scale signal. That is, a path which allows the display element 11 to emit light with a gray scale expressed by the gray-scale signal forms the path DISPLAY of the electric current and the gray-scale signal at the time of display.

In a blanking period which is the second period different from the first period, the detection voltage flows through two paths, that is, the detection path DETECT and the correction path REVISE. First of all, the display control part 3-1 does not supply the gray-scale signal. Then, the display control part 3-1 controls the detection switch 4 so as to electrically connect the detection circuit 5 and the detection-use power source 6 to the signal line DATA. Here, a drive current is supplied to the pixel circuit 2 from the detection-use power source 6. Further, a voltage obtained by the photoelectric conversion in the display element 11 which is constituted of a display element which does not emit light by an external light is outputted to the detection switch 4 via the pixel detection switch TFT3 of the pixel circuit 2 and the signal line DATA. By inputting a pulse to the detection control line DET, the pixel detection switch TFT3 of the pixel circuit 2 is turned on, and the detection voltage supplied to the detection switch 4 is inputted into the detection circuit 5. This path forms the detection path DETECT. Further, the reference element 10 is connected to the detection-use power source so that the detection voltage is supplied to the detection circuit 5.

The detection circuit 5 generates a correction signal in response to the detection voltage and supplies the correction signal to the display control part 3-1. The display control part 3-1 corrects the gray-scale signal in response to the inputted correction signal. This path forms the correction path REVISE.

As described above, the display path (DISPLAY) which is the supply path of the gray-scale signal from the display control part 3-1 to the pixel circuit 2, the supply path (DETECT) of the detection voltage from the pixel circuit 2 to the detection circuit 4, and the supply path (REVISE) of the correction signal from the detection circuit 4 to the display control part 3-1 use the same path on the signal line DATA in common between the detection switch 4 and the pixel circuit 2. However, these three paths differ from each other with respect to the path from the detection switch 4 to the display control part 3-1 as well as input/output terminals toward the signal drive circuit HDRV. Further, in this embodiment, the number of power source is set to two, that is, the display-use power source (voltage) 7 and the detection-use power source (current) 6. However, depending on the constitution of the organic EL display device, the number of power sources may be increased or decreased. Also with respect to a kind of power sources, either one of the current source and the voltage source may be selected.

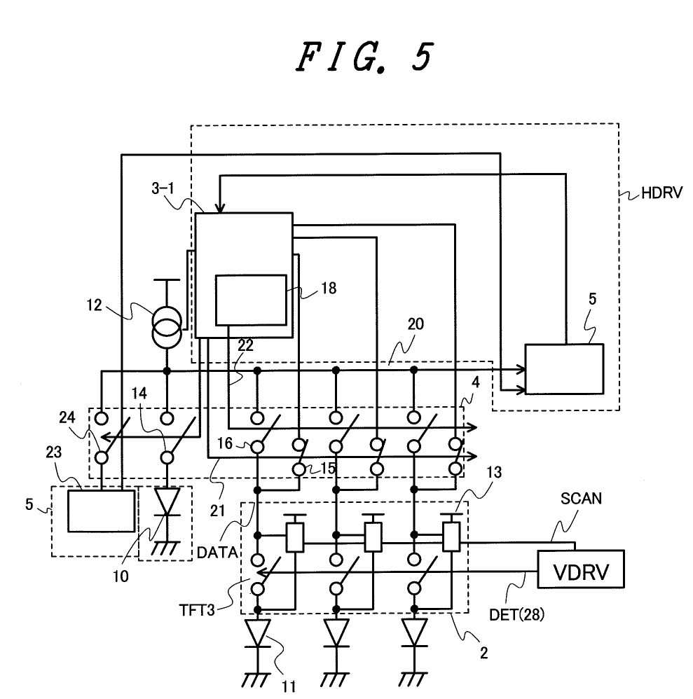

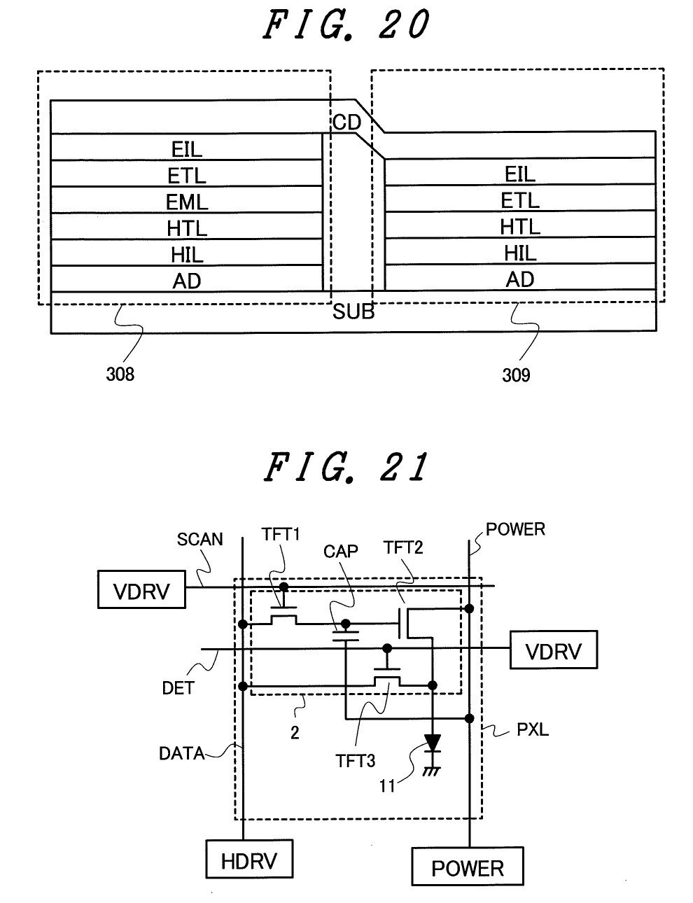

FIG. 5 shows the system constitution of the display panel shown in FIG. 4 in more detail. The organic EL display device includes the reference element 10 which is used as the light receiving element, and the display elements 11 which are used as the light emitting element/light receiving elements. FIG. 20 shows the layered structures of these organic thin film elements. The reference element 10 is an organic thin film element having the light receiving element structure 309 shown in FIG. 20, and the display element 11 is an organic thin film element having the light emitting/receiving element structure 308 shown in FIG. 20.

The light receiving element structure 309 is constituted by forming an anode AD, a hole injection layer HIL, a hole transport layer HTL, an electron transport layer ETL, an electron injection layer EIL, and a cathode CD on the glass substrate SUB1 in this order. The light emitting/receiving element structure 308 is constituted by forming an anode AD, a hole injection layer HIL, a hole transport layer HTL, an organic light emitting layer EML, an electron transport layer ETL, an electron injection layer EIL, and a cathode CD on the glass substrate SUB1 in this order. As shown in FIG. 2 and FIG. 3, the hole transport layer HTL may be omitted.

When the organic thin film element used only as the light receiving element and the organic thin film element used not only as the light receiving element but also as the light emitting element are formed on the same substrate in this manner, although it is preferable that these two organic thin film elements adopt the same layered structure in view of the manufacturing process, it is not always necessary for these two organic thin film elements to have the same structure and hence, the organic thin film element used only as the light receiving element may be constituted of layers completely different from layers of the organic thin film element used not only as the light receiving element but also as the light emitting element. However, for simplifying the manufacturing process, it is preferable that the organic thin film element used only as the light receiving element may adopt some of the organic layers which constitute the organic thin film element used not only as the light receiving element but also as the light emitting element. Further, even when the organic thin film element used only as the light receiving element adopts the absolutely same material layers as the organic thin film element used not only as the light receiving element but also as the light emitting element, by making film thicknesses of the material layers different from each other, it is possible to enhance the photoelectric conversion efficiencies of both light emitting element and light receiving element. Further, when the organic thin film element is used only as the light receiving element, it is preferable that the organic thin film element adopts an organic layer which does not emit light with an external light. It is especially preferable for the organic thin film element used not only as the light receiving element but also as the light emitting element to eliminate a material layer corresponding to the light emitting layer, to use a material different from the light emitting element, or to change a film thickness thereof.

The reference element 10 is a light receiving element used only at the time of detection, and is not used for every frame different from the display element 11. That is, the reference element 10 is configured to detect the reference voltage in a state that a frequency of use of the reference element 10 is decreased thus suppressing the deterioration of the pixel. Further, the reference element 10 is arranged in a region where an external light is not incident.

The display elements 11 are arranged in the effective display region AR in a matrix array. The detection circuit 5 of this embodiment compares detection voltages of two kinds of the organic thin film elements, that is, the reference element 10 and the display element 11, and calculates the influence attributed to an external light based on the difference between the detection voltages. Further, the detection circuit 5 transmits the calculation result of the influence to the display control part 3-1 as a correction signal, and the display control part 3-1 calculates a correction quantity of the gray-scale signal and feedbacks the correction quantity of the gray-scale signal for display. Here, although the reference element 10 is provided to the constitution shown in the drawing, depending on the detection constitution, the display element 11 may be allocated to the reference element 10 and the reference voltage may be preliminarily held without providing the reference element 10.

The detection-use drive power source and the display-use drive power source are configured independently from each other. At the time of detection, a detection-use current source 12 (corresponding to the detection-use power source 6 shown in FIG. 4) is used, while at the time of display, a display-use voltage source 13 (corresponding to the display-use power source 7 shown in FIG. 4) is used. The detection-use current source 12 is not limited to the current source but may be also formed of a voltage source. The connection between the detection-use current source 12 and the reference element 10 is controlled by a switch 14. The switch 14 is configured to be turned on at the time of detection in response to a control signal of the display control part 3-1. The connection between the pixel circuit 2 and the display control part 3-1 is controlled by a switch 15. The switch 15 is configured to be turned on at the time of display in response to a control signal of the display control part. The connection between the detection-use current source 12 and the display element 11 is controlled by a switch 16. The switch 16 is configured to be turned on at the time of detection in response to a control signal of the display control part.

The switch 15 and the switch 16 correspond to the detection switch 4 shown in FIG. 4, and there is no possibility that the switch 15 and the switch 16 are simultaneously turned on. That is, the switch 15 and the switch 16 are alternatively operated. The display control part 3-1 performs controls, detections and corrections of the respective switches and power sources. A shift register 18 which controls the switch 16 is incorporated in the display control part 3-1. Here, although the shift register 18 may be arranged on the glass substrate SUB1 as an independent control part, the control of the shift register 18 is performed by the display control part 3-1. The switch 15 is controlled in response to a control signal 21 outputted from the display control part 3-1. The switch 16 is controlled in response to a control signal 22 outputted from the display control part 3-1. The detection-use current source 12 and the switch 14 are connected to each other via a detection line 20.

The signal line DATA is a common-use line to which a gray-scale signal is supplied from the display control part 3-1 at the time of display and through which a detection voltage is applied to the detection circuit 5 at the time of detection. A holding part 23 is connected to the detection line 20 via a switch 24. When the switch 14 and the switch 24 are turned on, the holding part 23 holds a voltage applied to the reference element 10, and sets a value of the holding voltage as the reference voltage. The switch 14 and the switch 24 are controlled in response to a control signal outputted from the display control part 3-1.

The detection circuit 5 compares a reference voltage of the holding part 23 and the detection voltage of the display element 11 supplied via the detection line 20, generates a correction signal based on a comparison result, and outputs the correction signal to the display control part 3-1. Since the output data of the holding part 23 is a voltage, the comparison can be performed using a comparator or the like. Further, when the voltage difference is minute, the detection voltage may be amplified by providing an amplifier to the detection circuit 5 thus increasing the detection accuracy. The display-use voltage sources 13 and the display elements 11 are connected with each other in the pixel circuit 2. Although the power sources are separately provided as the detection-use current source 12 and the display-use voltage sources 13 in the drawing, depending on the detection constitution, these sources may be merged into either one of current source or the voltage source. The signal lines DATA and the display element 11 are connected with each other via pixel detection switches TFT3. The pixel detection switches TFT3 are controlled in response to a control signal 28 supplied to a detection control line DET from the scanning line drive circuit DRV.

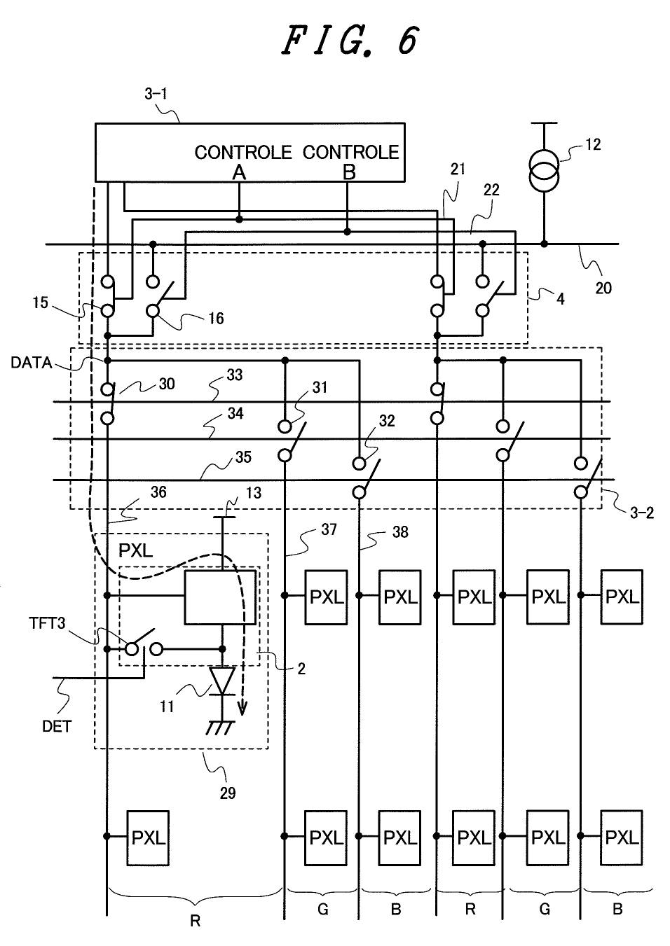

FIG. 6 is a constitutional view of a panel system which shows a signal path between the display elements and other systems in a display mode. The pixel PXL is constituted of the display element 11 and the pixel circuit 2. The pixel detection switch TFT3 of the pixel circuit 2 is controlled in response to a control signal supplied to the detection control line DET. In this embodiment, the selection of pixels PXL of R, G, B is configured to be controlled based on time division. The signal lines DATA of respective pixels are connected to a color selection circuit 3-2 (an R selection switch 30, a G selection switch 31, a B selection switch 32). The R selection switch 30 is controlled in response to an R selection signal 33. The G selection switch 31 is controlled in response to a G selection signal 34. The B selection switch 32 is controlled in response to a B selection signal 35. The respective pixels of R and the R selection switches 30 are connected with each other by signal lines 36. The respective pixels of G and the G selection switches 31 are connected with each other by signal lines 37. The respective pixels of B and the B selection switches 32 are connected with each other by signal lines 38. Although the control signals (R selection signal 33, G selection signal 34, B selection signal 35) of the color selection circuit 3-2 are controlled by the display control part 3-1 in this embodiment, these control signals may be controlled by other independent circuit.

Next, the manner of operation of the panel system shown in FIG. 6 is explained. In the display mode, in response to the control signal 21 and the control signal 22 from the display control part 3-1, the switches 15 are turned on and the switches 16 are turned off. In this state, a gray-scale signal from the display control part 3-1 is supplied to the signal line DATA. Then, at the time of performing the display of R pixels, the R selection switches 30 which are subject to a time-division control are turned on, the G selection switches 31 which are subject to the time-division control are turned off, the B selection switches 32 which are subject to the time-division control are turned off, and the pixel detection switches TFT3 of all pixels assume an OFF state. Here, the pixel circuit 2 controls a quantity of electric current which flows into the display element 11 from the display-use voltage source 13 based on a gray-scale signal from the display control part 3-1. As the result, the display pixels emit light with brightness corresponding to the gray-scale signal of R.

In the same manner, at the time of performing the display of G pixels, the G selection switches 31 which are subject to a time-division control are turned on, the R selection switches 30 which are subject to the time-division control are turned off, the B selection switches 32 which are subject to the time-division control are turned off, and the pixel detection switches TFT3 of all pixels assume an OFF state. Here, the pixel circuit 2 controls a quantity of electric current which flows into the display element (light emitting element/light receiving element) 11 from the display-use voltage source 13 based on a gray-scale signal from the display control part 3-1. As the result, the G pixels emit light with brightness corresponding to the gray-scale signal of G. Further, at the time of performing the display of B pixels, the B selection switches 32 which are subject to a time-division control are turned on, the R selection switches 30 which are subject to the time-division control are turned off, the G selection switches 31 which are subject to the time-division control are turned off, and the pixel detection switches TFT3 of all pixels assume an OFF state. Here, the pixel circuit 2 controls a quantity of electric current which flows into the display element 11 from the display-use voltage source 13 based on a gray-scale signal from the display control part 3-1. As the result, the display elements 11 emit light with brightness corresponding to the gray-scale signal of B. In this manner, the respective switches are controlled so that the display elements 11 sequentially emit light.

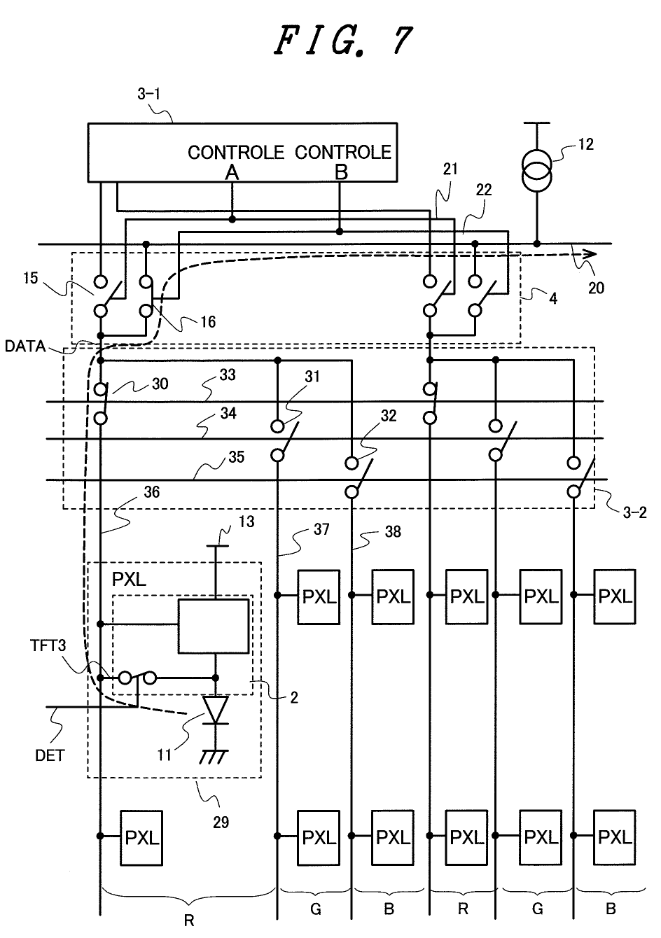

FIG. 7 is a constitutional view of the panel system which shows a signal path between the display elements and other systems in the detection mode. In this detection mode, in response to a control signal 21 and a control signal 22 from the display control part 3-1, the switches 15 are turned off and the switches 16 are turned on. In this state, the signal line DATA of the pixel to be detected and the detection line 20 are connected with each other. The pixel to be detected is selected in response to a control signal supplied from the detection control line DET.

Further, in the detection mode, it is necessary to read a state of the display element 11 of the pixel to be detected and hence, the display control part 3-1 interrupts the supply of the voltage from the display-use voltage source 13 to the pixel circuit 2. By turning on the pixel detection switch TFT3 thus connecting the display element 11 with the signal line DATA in this state, an electric current is supplied from the detection-use current source 12 thus allowing the detection of a voltage by photoelectric conversion.

To be more specific, in detecting a received light quantity of the R pixel, the R selection switch 30 is turned on, and the pixel detection switch TFT3 of the display element (light emitting element/light receiving element) 11 of the pixel to be detected is turned on. The detection-use current source 12 is connected to the detection line 20, and a fixed voltage is generated in the signal line 36 due to the photoelectric conversion characteristic of the display element 11 of the pixel to be detected and hence, a state (voltage) of the display element 11 appears in the detection line 20. Here, when the display element 11 emits light, a contrast is lowered and hence, display quality of the panel is lowered. Accordingly, a current value of the electric current from the detection-use current source 12 is set to a value which prevents the light emitting element from emitting light.

In the same manner, in detecting the G pixel, the G selection switch 31 is turned on and the pixel detection switch of the pixel to be detected is turned on and hence, a state of the display element 11 of the pixel to be detected appears in the detection line 20 via the signal line 37. Further, in detecting the B pixel, the B selection switch 32 is turned on and the pixel detection switch of the pixel to be detected is turned on and hence, a state of the display element 11 of the pixel to be detected appears in the detection line 20.

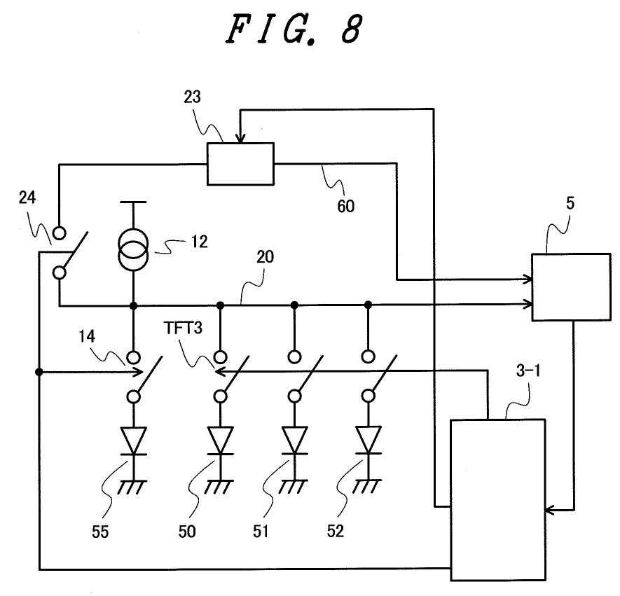

FIG. 8 is a constitutional view of a panel system which also includes a reference element 10. The manner of detecting operation is explained in conjunction with the constitutional view of the panel system. In the described constitution, the detection switch 4 and the like are omitted. Here, one current source is used, a reference element 55 (corresponding to the reference element 10 shown in FIG. 4) and a detection voltage of the reference element 55 and a detection voltage of a display elements 50, 51, 52 (corresponding to the display element 11 shown in FIG. 4) are compared to each other. A reference line 60 is connected to a holding part 23 for holding a reference voltage. A detection-use current source 12 used in common is connected to the detection line 20 and, further, the display element 50, the display element 51, the display element 52 and all other display elements are respectively connected to the detection line 20 via the respective pixel detection switches TFT3. The reference element 55 is connected to the detection line 20 via a switch 14, and the holding part 23 is connected to the detection line 20 via a switch 24. The pixel detection switches TFT3, the switch 14 and the switch 24 are controlled in response to a control signal from the display control part 3-1.

Next, the manner of operation of the panel system constitution shown in FIG. 8 is explained. The display control part 3-1 turns on the switch 14 and the switch 24 and turns off all pixel detection switches TFT3. In this state, the detection-use current source 12 and the reference element 55 are connected with each other, and a voltage at the time is held in the holding part 23. Thereafter, with a control performed by the display control part 3-1, the holding part 23 holds this value and continues outputting of the value to the reference line 60. When the processing of the reference element 55 is finished, using a shift register 18 in the display control part 3-1, the display element 50 is connected to the detection line 20 via the pixel detection switch TFT3. The detection circuit 5 performs a comparison of the detection voltages supplied from the reference line 60 and the detection line 20 and generates a correction signal, and outputs the correction signal to the display control part 3-1. Upon inputting of the correction signal to the display control part 3-1 from the detection circuit 5, the display control part 3-1 connects the display element 51 to the detection line 20 via the pixel detection switch TFT3 using the shift register 18. Then, the detection circuit 5 performs a comparison of the reference line 60 and the detection line 20, generates a correction signal, and outputs the correction signal which is a result of the comparison to the display control part 3-1. In this manner, the voltage detected from the reference element 55 is sequentially compared with the voltages detected from all display elements 50, 51, 52.

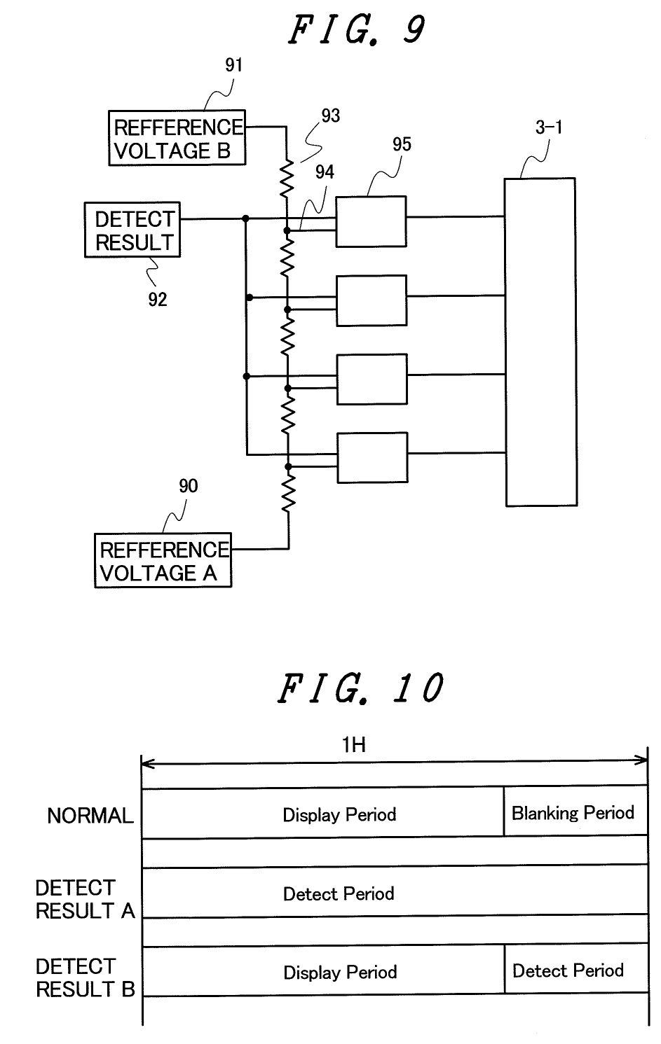

FIG. 9 shows a constitutional example of the detection circuit 5. In the detection circuit 5, a reference voltage 90 and a reference voltage 91 detected from the reference line 60 are compared with a detection result 92 (detection voltage) of the display element detected from the detection line 20. One of the reference voltage 90 and the reference voltage 91 is assumed to have a value of a reference line, and another is assumed to have a value which is obtained by adding an offset value to the value or by subtracting the offset value from the value. A reference value 94 used in comparison is assumed to be a value which is obtained by dividing the reference voltage 90 and the reference voltage 91 with a resistance ladder 93. Comparators 95 compare the detection result 92 and the reference value 94.

Although four comparators 95 are used in this embodiment, the number of comparators 95 and the division number of the resistance ladder 93 are increased or decreased depending on the accuracy of comparison. The detection result obtained by the comparators 95 is processed by the display control part 3-1, and is fed back by correcting voltage values allocated in response to gray-scale signals of the display element 1110.

FIG. 10 shows timing of detection. A 1 horizontal period of an organic EL display device NORMAL having no light receiving elements is formed of a display period and a blanking period. In the detection method A (DETECT RESULT A), all period including the display period and the blanking period is used as a detection period. In this case, no display is performed during detection. In the detection method B (DETECT RESULT B), the display period remains as it is and all or part of the blanking period is allocated to the detect period. In this case, the detection is performed while continuing the display and hence, although the detection of one whole screen takes time compared to the detection method A, the display period is not influenced.

FIG. 11 is a flowchart of detection flow in the display control part 3-1 and the detection circuit 5. When the detection process is started in step 100, the display control part 3-1 resets a vertical counter (step 111). The display control part 3-1 determines whether or not the detection period has arrived (step 112), turns on the switches 23, 24 when the detection period has arrived, allows the detection circuit 5 to measure the reference voltage (step 113), and allows the holding part 23 to hold the reference voltage which is a result of processing in step 113 (step 114). The display control part 3-1 sets the shift register for changing over the respective pixels, turns off the switch 15, turns on the switch 16 thus supplying a control signal to the detection control line DET from the scanning line drive circuit VDRV to turn on the pixel detection switch TFT3 (step 115). The detection circuit 5 detects a voltage generated by the display element 10 which constitutes the pixel to be detected (step 116). The display control part 3-1 waits for a response from the detection circuit 5 (step 117). The display control part 3-1 determines a detection state when the voltage is detected by the detection circuit 5 (step 118), while the display control part 3-1 performs error processing when the voltage is not detected by the detection circuit 5 (step 119).

The display control part 3-2 determines whether or not the detection of 1 line is finished when the detection in step 118 is determined to be normal (step 120), and the display control part 3-2 moves the shift register when the detection is in the midst of 1 line and detects a remaining line of 1 line (step 121). When the detection of 1 line is finished by repeating steps ranging from step 116 to step 120, the detection circuit 5 generates a correction signal, and the display control part 3-1 executes correction processing (step 122). The display control part 3-1 determines whether or not the detection of the screen is finished (step 123), and counts up the vertical counter when the detection of the screen is in the midst of 1 screen, and detects a remaining portion of the screen (step 124). The display control is executed by repeating steps up to step 124, and the detection is finished when the detection of 1 screen is finished (step 125).

Due to the above-mentioned constitution and manner of operation, it is possible to manufacture an organic EL display device having a light detection function without separately adding an expensive optical system, an expensive mechanical system, expensive sensors, expensive lighting devices or the like. In this manner, with the provision of the external light detection system per coordinates, it is also possible to provide a highly-value-added application referred to as an OLED module which incorporates a touch panel function, a handwriting inputting function or a function of automatically adjusting light emitting brightness by external illumination.

### EMBODIMENT 2

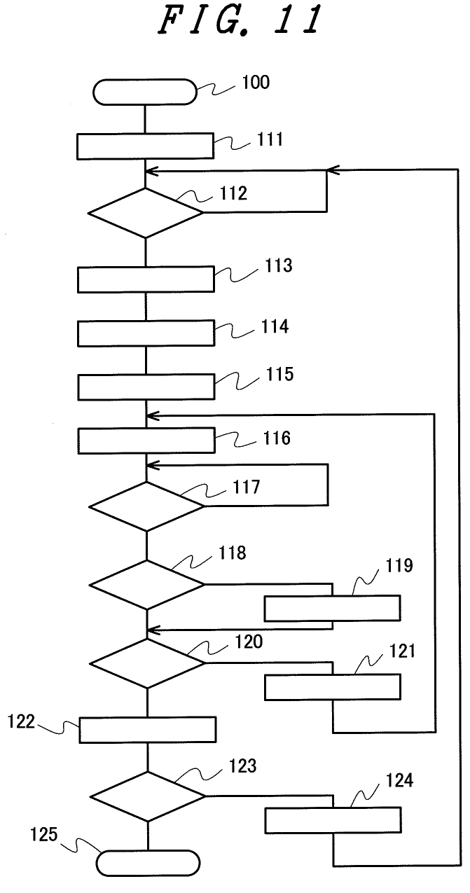

FIG. 12 shows one constitutional example relating to the reference element, the detection line and the display element. In this constitution, one current source is used, a plurality of reference elements is used, and the reference elements and the display elements are compared with each other. Further, this embodiment also provides the constitution which detects the plurality of elements collectively. Assuming the number of elements to be detected simultaneously as n pieces, n pieces of reference pixels are prepared and a current supply quantity of the current source is increased n times with respect to one-piece detection.

A reference line 60 is connected to a holding part 23 for holding a reference voltage. A detection-use current source 12 used in common is connected to the detection line 20 and, further, the display element 50 (corresponding to the display element 11 shown in FIG. 4), the display element 51 (corresponding to the display element 11 shown in FIG. 4), the display element 52 (corresponding to the display element 11 shown in FIG. 4), the display element 53 (corresponding to the display element 11 shown in FIG. 4) and all other display elements are respectively connected to the detection line 20 via the separately-provided pixel detection switches TFT3. The reference element 56 (reference element 10 in FIG. 4) and a reference element 57 (reference element 10 in FIG. 4) are connected to the detection line 20 via a switch 14, and the holding part 23 is connected to the detection line 20 via a switch 24. The pixel detection switches TFT3, the switch 14 and the switch 24 are controlled by the display control part 3-1.

Next, the manner of operation of the panel system constitution shown in FIG. 12 is explained. The display control part 3-1 turns on the switch 14 and the switch 24 and turns off all pixel detection switches TFT3. In this state, the detection-use current source 12 is connected with the reference element 56 and the reference element 57, and a voltage at the time is held in the holding part 23. Thereafter, with a control performed by the display control part 3-1, the holding part 23 holds this value until the detection of 1 cycle is finished, and continues outputting of the value to the reference line 60. This constitutional example uses two reference elements and hence, provided that these reference elements have the substantially same characteristic, an electric current of the detection-use current source 12 flows into the reference elements in halves whereby the detection quantity becomes substantially equal to the detection quantity when one reference element is used. Further, when the reference elements differ from each other in the characteristics, an average characteristic is adopted.

When the detection processing using the reference elements 56, 57 is finished, the pixel detection switch TFT3 is turned on using the shift register 18 in the display control part 3-1 so as to connect the display element 50 and the display element 51 to the detection line 20. The detection quantity becomes an average quantity of the respective pixels. The detection circuit 5 performs a comparison of the detection voltage of the reference line 60 and the detection voltage of the detection line 20 and generates a correction signal from the comparison result, and outputs the correction signal to the display control part 3-1. Upon inputting of the correction signal to the display control part 3-1 from the detection circuit 5, the display control part 3-1 connects the display element 52 and the display element 53 to the detection line 20 via the pixel detection switch TFT3 using the shift register 18. Then, the detection circuit 5 performs a comparison of the detection voltage of the reference line 60 and the detection voltage of the detection line 20, and outputs the result (correction signal) to the display control part 3-1. In this manner, the comparison detection is collectively performed with respect to the plurality of pixels.

### EMBODIMENT 3

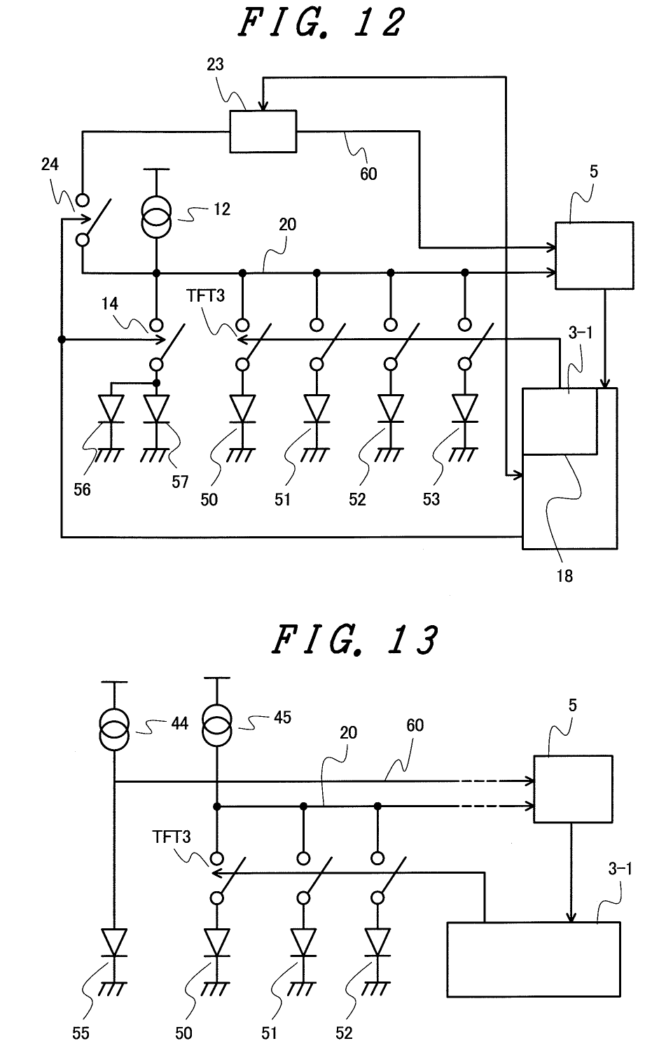

FIG. 13 shows one constitutional example relating to the reference element, the detection line and the display element. In this constitution, a reference element is used in addition to the display elements, and the detection voltage of the reference element and the detection voltages of the display elements are compared with each other. A reference element 55 (corresponding to the reference element 10 shown in FIG. 4) and a detection-use current source 44 (corresponding to the detection-use current source 6 shown in FIG. 6) are connected to the reference line 20. Although only one kind of reference pixel is connected to the reference line 60 in this constitutional example, a plurality of reference elements may preferably be selectively connected to the reference line using a switch. The display element 50 (corresponding to the display element 11 shown in FIG. 4), the display element 51 (corresponding to the display element 11 shown in FIG. 4), the display element 52 (corresponding to the display element 11 shown in FIG. 4) are respectively connected to the detection line 20 via the pixel detection switches TFT3. Further, a detection-use current source 45 is connected to the detection line 20. The significant technical feature of this constitutional example lies in that the detection-use current source 12 used in the previous embodiments is divided in two, and these divided detection-use current sources are separately used for the reference element and the display elements respectively.

Next, the manner of operation of the panel system constitution shown in FIG. 13 is explained. The detection is performed by comparing the detection voltage of the reference element 55 and the detection voltage of the display element 50, the detection voltage of the reference element 55 and the detection voltage of the display element 51, and the detection voltage of the reference element 55 and the detection voltage of the display element 52 in this order. The reference element 55 is fixedly connected to the reference line 60, and the display elements 50, 51, 52 are connected to the detection line 20 via the pixel detection switches TFT3. The detection circuit 5 performs a comparison of the detection voltages which are results of the detection of the reference line 60 and the detection line 20, and outputs the correction signal which is a result of the comparison to the display control part 3-1. Upon inputting of the result to the display control part 3-1 from the detection circuit 5, the display control part 3-1 connects the display element 51 to the detection line 20 via the pixel detection switch TFT3. Then, the detection circuit 5 performs a comparison of the detection voltage of the reference line 60 and the detection voltage of the detection line 20, and outputs the result to the display control part 3-1. In this manner, the correction signals are sequentially generated from the detection voltages of the respective display elements using the detection voltage of the reference element 55 as the reference.

### EMBODIMENT 4

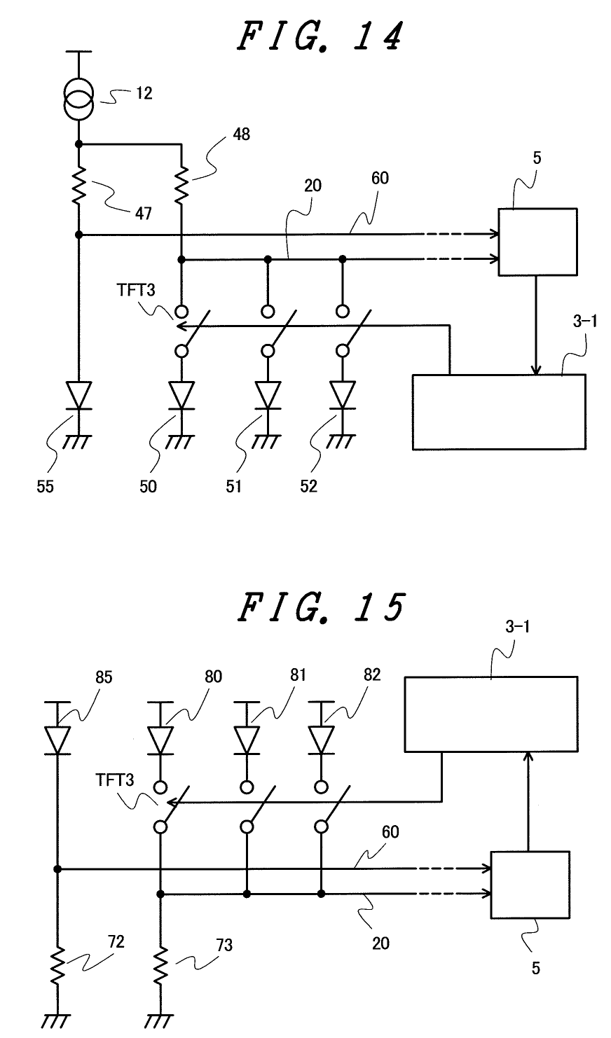

FIG. 14 shows one constitutional example relating to the reference element, the detection line and the display elements. In this constitution, the reference element is used in addition to the display elements, and the detection voltage of the reference element and the detection voltages of the display elements are compared with each other. Further, one current source is used in this constitution, and the reference line 60 and the detection line 20 use the detection-use current source 12 in common. The reference element 55 (corresponding to the reference element 10 shown in FIG. 4) is connected to the reference line 60, and a current source 46 is connected to the reference line 60 via a resistance 47. Although only one kind of reference element is connected to the reference line 60 in this constitutional example, a plurality of reference pixels may preferably be selectively connected to the reference line using a switch. The display element 50 (corresponding to the display element 11 shown in FIG. 4), the display element 51 (corresponding to the display element 11 shown in FIG. 4), the display element 52 (corresponding to the display element 11 shown in FIG. 4) are respectively connected to the detection line 20 via the pixel detection switches TFT3. Further, a detection-use current source 12 is connected to the detection line 20 via a resistance 48. Next, the manner of operation of the panel system constitution shown in FIG. 14 is explained. The detection is performed by comparing the detection voltage of the reference element 55 with the detection voltage of the display element 50, the detection voltage of the reference element 55 with the detection voltage of the display element 51, and the detection voltage of the reference element 55 with the detection voltage of the display element 52 in this order. The reference element 55 is fixedly connected to the reference line 60, and the display element 50 is connected to the detection line 20 via the pixel detection switches TFT3. Since the detection-use current source 12 is used in common, when the electric characteristic of the reference element 55 and the electric characteristic of the display element 50 are not equal, the minute voltage difference is generated between the reference line 60 and the detection line 20. When the electric characteristic of the reference element 55 and the electric characteristic of the display element 50 are equal, the voltage difference is not generated between the reference line 60 and the detection line 20. The detection circuit 5 performs a comparison of the detection voltage of the reference line 60 and the detection voltage of the detection line 20, and outputs the correction signal which is a result of the comparison to the display control part 3-1. Upon inputting of the result (correction signal) to the display control part 3-1 from the detection circuit 5, the display control part 3-1 connects the display element 51 to the detection line 20 via the pixel detection switch TFT3. Then, the detection circuit 5 performs a comparison of the detection voltage of the reference line 60 and the detection voltage of the detection line 20, and outputs the comparison result to the display control part 3-1. In this manner, the reference element is compared with the display elements sequentially.

### EMBODIMENT 5

FIG. 15 shows one constitutional example relating to the reference element, the detection line and the display elements. In this constitutional example, the display elements are connected with a power source (voltage source) by a node grounding. Further, the reference element and the display elements are operated using the voltage source and a fixed resistance in place of the current source. The reference element 85 (corresponding to the reference element 10 shown in FIG. 4) and a resistance 72 are connected to the reference line 60. A resistance 73 is connected to the detection line 20 and, further, the display element 80 (corresponding to the display element 11 shown in FIG. 4), the display element 81 (corresponding to the display element 11 shown in FIG. 4), the display element 82 (corresponding to the display element 11 shown in FIG. 4), and all other display elements are connected to the detection line 20 via the pixel detection switches TFT3. The pixel detection switches TFT3 are controlled by the display control part 3-1.

Next, the manner of operation of the panel system constitution shown in FIG. 15 is explained. A reference voltage appears in the reference line 60 due to the provision of the reference element 85 and the resistance 72. The detection is performed by comparing the detection voltage of the reference element 85 with the detection voltage of the display element 80, the detection voltage of the reference element 85 with the detection voltage of the display element 81, and the detection voltage of the reference element 85 with the detection voltage of the display element 82 in this order. The display control part 3-1 connects the display element 80 to the detection line 20 via the pixel detection switch TFT3. The detection circuit 5 performs a comparison of the detection voltage of the reference line 60 and the detection voltage of the detection line 20, and outputs the correction signal formed of a gray-scale signal which is a result of the comparison to the display control part 3-1. Upon inputting of the correction signal formed of the gray-scale signal which is a result of the comparison to the display control part 3-1 from the detection circuit 5, the display control part 3-1 connects the display element 81 to the detection line 71 via the pixel detection switch TFT3. Then, the detection circuit 5 performs a comparison of the detection voltage of the reference line 60 and the detection voltage of the detection line 20, and outputs the correction signal formed of the gray-scale signal which is a result of the comparison to the display control part 3-1. In this manner, the respective display elements are sequentially compares with the reference element 85 which constitutes the reference.

### EMBODIMENT 6

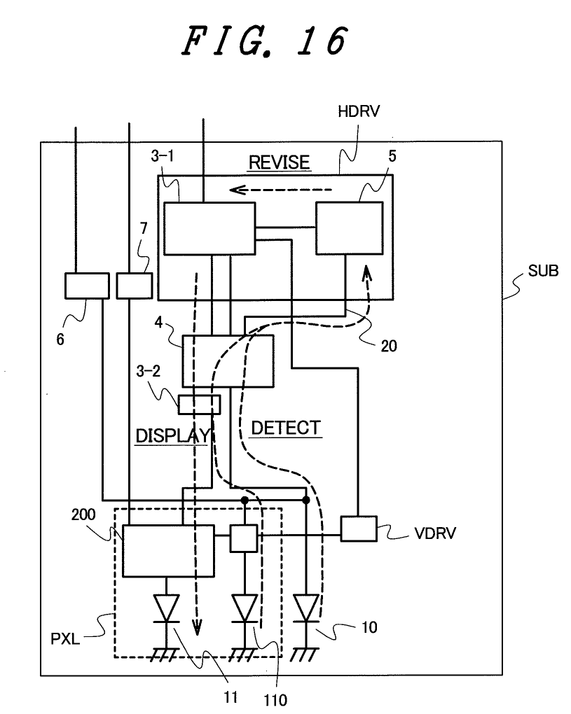

FIG. 16 is a basic constitutional view of a display panel which forms one pixel using a light receiving element and a light emitting element as a set. In FIG. 16, parts identical with the parts in the embodiment 1 are, unless otherwise specified, given the same symbols.

A display panel of the embodiment 6 includes a reference element 10, light-receiving-use elements 110, display elements 11, a pixel circuit 200, a display control part 3-1, a color selection circuit 3-2, a detection switch 4, a detection circuit 5, a detection-use power source 6, a display-use power source 7, and a scanning line drive circuit VDRV on a glass substrate SUB1.

The display element 11 has the same structure as the element structure 308. That is, the display element 11 is constituted by stacking an anode AD, a hole injection layer HIL, a hole transport layer HTL, an organic light emitting layer EML, an electron transport layer ETL, an electron injection layer EIL, and a cathode CD on the substrate SUB1 in this order. On the other hand, the reference element 10 and the light-receiving-use element 110 have the same structure as the element structure 309. That is, the reference element 10 and the light-receiving-use element 110 are respectively constituted by stacking an anode AD, a hole injection layer HIL, a hole transport layer HTL, an electron transport layer ETL, an electron injection layer EIL, and a cathode CD on the glass substrate SUB1 in this order.

The large difference between the element structure 308 and the element structure 309 lies in that the element structure 309 uses some of organic layers which constitute the element structure 308 but do not use remaining organic layers which also constitute the element structure 308. To be more specific, the element structure 309 includes the hole injection layer HIL, the hole transport layer HTL, the electron transport layer ETL, and the electron injection layer EIL which constitute the element structure 308 but does not include the organic light emitting layer EML. By constituting the element structure 309 using one or more layers other than the organic light emitting layer in this manner, it is possible to simplify a manufacturing process. Further, the organic light emitting layer is not used and hence, it is possible to prevent the emission of light attributed to an electric current generated by the photoelectric conversion of an external light. Further, even when the organic light emitting layer EML used in the element structure 308 is used in the element structure 309, it is preferable to make a film thickness of the organic light emitting layer EML used in the element structure 309 different from a film thickness of the organic light emitting layer EML used in the element structure 308. This is because that the light receiving efficiency can be enhanced due to such a constitution.

Further, also when the organic light emitting layer EML used in the element structure 308 is used in the element structure 309, to prevent the reference element 10 and the light-receiving-use element 110 from emitting light attributed to an external light, especially, a natural light, it is preferable to control respective materials and respective film thicknesses of the hole injection layer HIL, the hole transport layer HTL, the organic light emitting layer EML, the electron transport layer ETL, and the electron injection layer EIL. Further, when some of the organic layers constituting the element structure 308 are used in the element structure 309, it is preferable to use a layer formed of a so-called matted film which is used in common by all pixels in place of layers formed in the same pattern as the organic light emitting layer EML.

FIG. 23 shows the constitution of the pixel circuit 200 for controlling the light emission of the display element 11.

The pixel circuit 200 is constituted of a data latch switch TFT1, a capacitor CAP and a pixel drive switch TFT2. A control line of the data latch switch TFT1 is constituted of a scanning line SCAN, and is configured to control the connection between the signal line DATA and one end of the capacitor CAP. One end of the capacitor CAP is also connected to a control end of the pixel drive switch TFT2. Another end of the capacitor CAP is connected between the pixel drive switch TFT2 and the display element 11. The pixel drive switch TFT2 controls the connection between a power source line POWER and the display element 11.

When a control signal supplied from a scanning line drive circuit VDRV is applied to the scanning line SCAN and the data latch switch TFT1 is turned on, a voltage corresponding to a gray-scale signal is fetched in the capacitor CAP. The pixel drive switch TFT2 is turned on in response to a voltage held by the capacitor, and a quantity of electric current which flows into the light emitting element 308 from the power source line POWER is controlled. The power source line POWER is connected to the display-use power source 7, and the signal line DATA is connected to the detection switch 4 via the color selection circuit 3-2. The scanning line SCAN is connected to the scanning drive circuit VDRV.

The display control part 3-1 is provided to a signal line drive circuit HDRV shown in FIG. 22. A display panel shown in FIG. 22 performs a display mode in which the display control part 3-1 controls the detection switch 4 so as to bring the color selection circuit 3-2 and the display element into a conductive state and to bring the detection-use power source 6 and the light-receiving-use element 110 into a non-conductive state, and a detection mode in which the display control part 3-1 controls the detection circuit 4 so as to bring the color selection circuit 3-2 and the display element 11 into a non-conductive state and to bring the detection-use power source 6 and the light-receiving-use element 110 into a conductive state.

In the display mode, the display control part 3-1 also performs a control of the color selection circuit 3-2 to supply the gray-scale signal to a predetermined pixel. Further, in the detection mode, the display control part 3-1 applies a voltage from the predetermined pixel to the detection circuit 5. Further, in the detection mode, when a correction signal is inputted to the display control part 3-1 from the detection circuit 5, the display control part 3-1 corrects a gray-scale signal based on the correction signal.

The color selection circuit 3-2 is connected to the detection switch 4 and the pixel circuit 200. The color selection circuit 3-2, in the display mode, selects the signal line DATA into which the gray-scale signal flows.

The display control part 3-1, the detection circuit 5 and the detection-use power source 6 are provided to the signal line drive circuit HDRV shown in FIG. 22. A first terminal of the signal line drive circuit HDRV is connected to the color selection circuit 3-2 via the detection switch 4, while a second terminal which differs from the first terminal is connected to the detection switch 4 via the detection circuit 5.

The pixel circuit 200, the color selection circuit 3-2, the detection switch 4, the display-use power source 7, and the scanning line drive circuit VDRV, are respectively constituted of a thin film transistor, a low-temperature poly-silicon line, a gate metal line, a source drain metal line, and an interlayer insulation film which are formed on the grass substrate SUB1.

The detection switch 4 is controlled in response to a control signal from the display control part 3-1, and changes over the connection between the display control part 3-1 and the color selection circuit 3-2 and the connection of the light-receiving-use element 110 with the detection circuit 5 and the detection-use power source 6. The detection circuit 5 detects a magnitude of a voltage inputted into the detection circuit 5 due to the connection between the detection circuit 5 and the light-receiving-use element 110 by the detection switch 4, generates a correction signal based on the detection result, and supplies the correction signal to the display control part 3-1. The display-use power source 7 supplies a drive current to the pixel circuit 200.

Next, the manner of operation of the panel system shown in FIG. 16 is explained. A path of a signal is roughly classified into three paths, that is, a display path DISPLAY, a detection path DETECT, and a correction path REVISE. These paths are sequentially changed with time. Here, in this specification, a behavior which reflects a light detection result on a display state based on an arbitrary mode is referred to as “correction”. The gray-scale signal which is outputted from the display control part 3-1 in a first display period in which display is performed is inputted into the pixel circuit 200 through the detection switch 4, the color selection circuit 3-2, and the signal line DATA. The pixel circuit 200 performs a control such that a quantity of electric current which flows in the display element 11 from the display-use power source 7 assumes a quantity of electric current corresponding to the gray-scale signal. That is, a path which allows the display element 11 to emit light with a gray scale expressed by the gray-scale signal forms the path DISPLAY of the electric current and the gray-scale signal at the time of display. A path in which the electric current and the gray-scale signal flow into the detection circuit 5 from the reference element 10 and the light-receiving-use element 110 (via the detection switch 4) during a second detection period in which the detection of voltages generated in the reference element 10 and the light-receiving-use element 110 and the correction of the gray-scale signal are performed forms the detection path DETECT. A path in which the electric current and the gray-scale signal flow into the display control part 3-1 from the detection circuit 5 for forming the gray-scale signal forms the correction path REVISE. A drive power source of the display element 11 in the first period is the light-emitting-use voltage source 7, and drive power sources of the reference element 10 and the light-receiving-use element 110 in the second period is the detection-use current source 6. In this embodiment, although the number of power source is set to two, depending on the constitution of the organic EL display device, the number of power sources may be increased or decreased. Also with respect to a kind of power sources, the current source, the voltage source or the like is changed depending on the constitution of the organic EL display device.

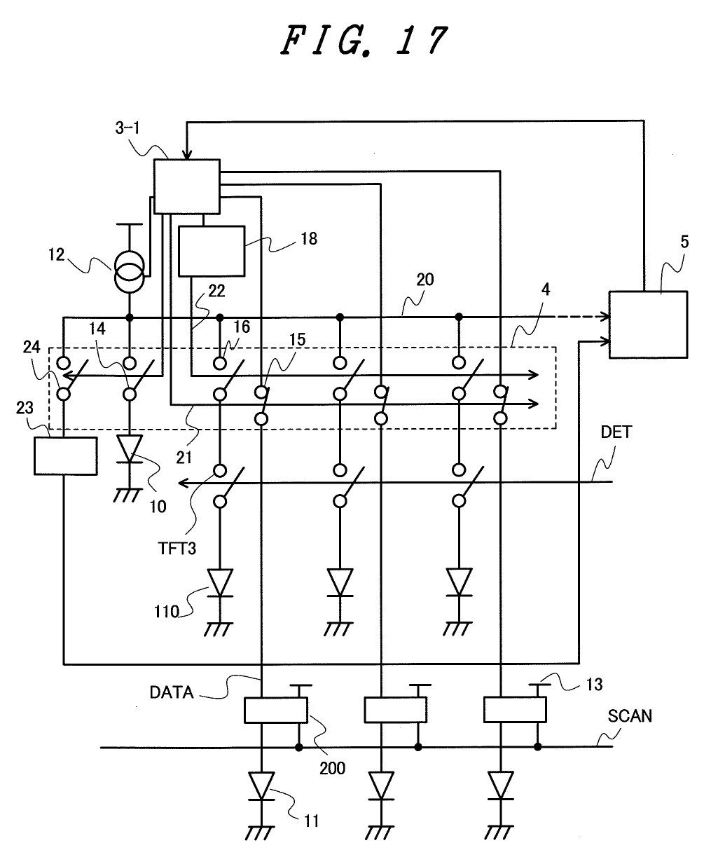

FIG. 17 shows one example of the system constitution of the display panel shown in FIG. 16. In the inside of the display device, the reference element 10, the display elements 11 and the light-receiving-use elements 110 are present as pixels. The reference element 10 is an element which is used only at the time of performing the detection, and the reference element 10 is used as a reference of the detection comparison in a state that a frequency of use of the reference element 10 is decreased for suppressing the deterioration of the pixel. Further, to achieve the above-mentioned object, it is always necessary to arrange the reference element 10 in a region where an external light is not incident. The display element 11 is an element which is always used at the time of driving. In performing the detection, two pixels, that is, the light-receiving-use element 110 and the reference element 10 are compared to each other, and a state of pixel is obtained based on the difference between two pixels. A correction quantity is calculated by the control part based on the comparison result and the correction quantity is fed back to a display image. Here, in the drawing, although the reference element 10 is provided, depending on the detection constitution, the reference element 10 may be allocated to the light-receiving-use element 110.

The detection-use drive power source and the display-use drive power source are configured independently from each other. At the time of performing the detection, a detection-use current source 12 (corresponding to the detection-use power source 6 shown in FIG. 16) is used, while at the time of display, a display-use voltage source 13 (corresponding to the display-use power source 7 shown in FIG. 16) is used. The detection-use current source 12 is not limited to the current source but may be also formed of a voltage source. The detection-use current source 12 and the reference element 10 are connected to each other using a switch 14. The switch 15 is configured to be turned on at the time of display. The detection-use current source 12 and the light-receiving-use element 110 are connected to each other using a switch 16 and a pixel detection switch TFT3. Here, there is no possibility that the switch 15 and the switch 16 are simultaneously turned on.

The display control part 3-1 performs controls, detections and corrections of the respective switches and power sources. A shift register 18 controls the switch 16. The shift register 18 may be incorporated in the display control part 3-1 or may be arranged as a control part independent from the display control part 3-1. However, the control of the shift register 18 is performed by the display control part 3-1. The signal line DATA is used at the time of display. The switch 15 is controlled in response to a control signal 21 outputted from the display control part 3-1. The switch 16 is controlled in response to a control signal 22 outputted from the display control part 3-1.

The detection-use current source 12 and the switch 14 are connected to each other using the detection line 20. The holding part 23 is connected to the detection line 20 using a switch 24. When the switch 14 and the switch 24 are turned on, the holding part 23 holds a voltage applied to the reference element 10, and sets a value of the holding voltage as the reference voltage. The detection circuit 5 compares a detection voltage inputted from the holding part 23 and a detection voltage inputted from the detection line 20, and outputs the comparison result to the display control part 3-1. Since the detection data is detected as a voltage, the comparison can be performed using a comparator or the like. Further, when a value of the detection result is minute, the detection voltage may be amplified by providing an amplifier to the detection circuit 5 thus increasing the detection accuracy. The display-use voltage sources 13 and the display elements 11 are connected with each other in the pixel circuit 200. Although the power sources are separately provided as the detection-use current source 12 and the display-use voltage sources 13 in the drawing, depending on the detection constitution, these sources may be merged into either one of the current source or the voltage source. The data latch switch TFT1 for scanning the display element 11 in the horizontal direction is incorporated in the pixel circuit 200, and a control of the data latch switch TFT1 is performed by inputting a control signal 28 controlled by the display control part 3-1 to the scanning line SCAN. Further, a control of the pixel detection switch TFT3 for scanning the light receiving element 309 in the horizontal direction is performed in response to a control signal controlled by the display control part 3-1.

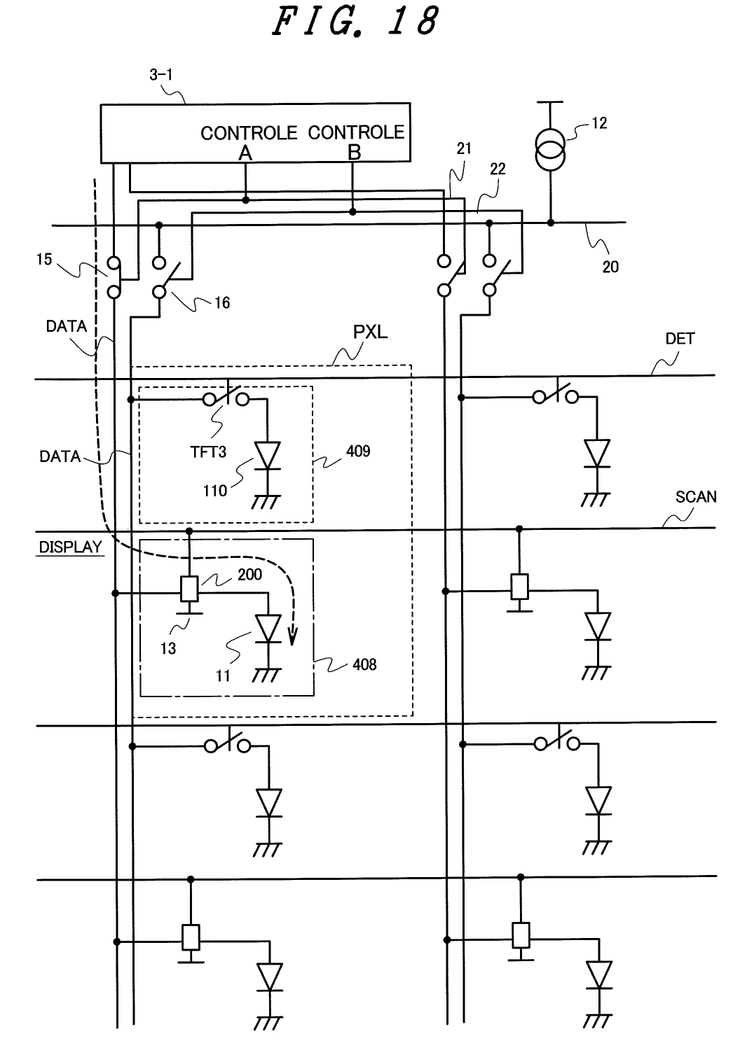

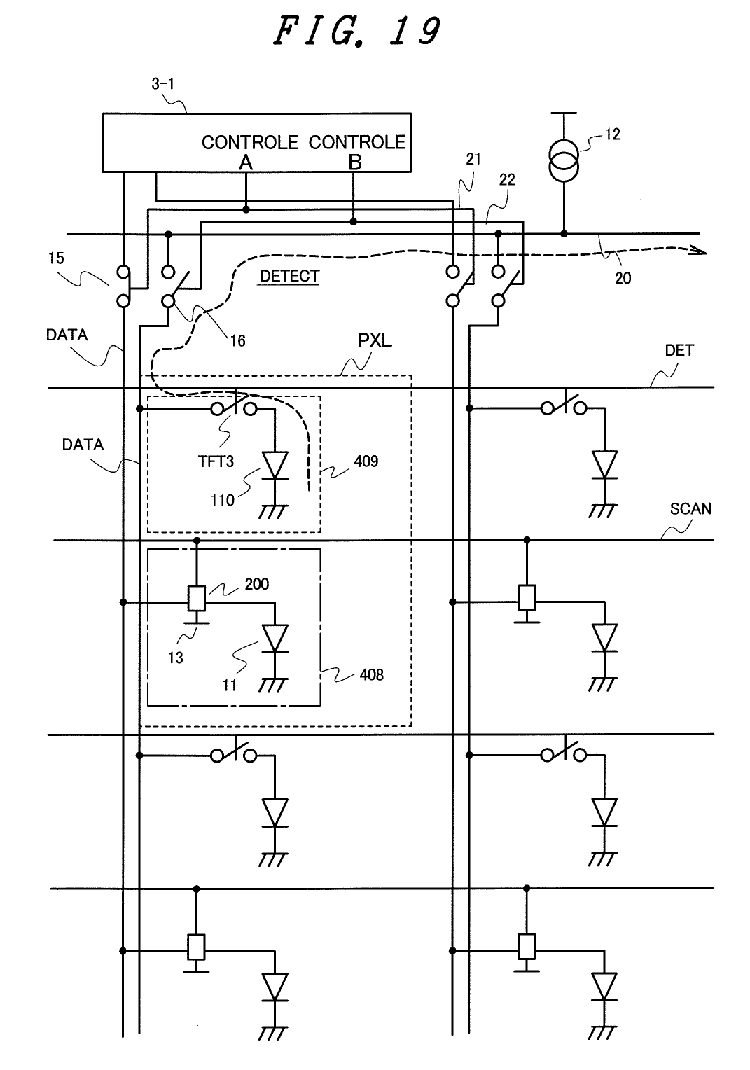

FIG. 18 and FIG. 19 show constitutional examples of a periphery of the signal line DATA. FIG. 18 shows a state of the periphery of the signal line DATA at the time of display.

A pixel PIXEL is constituted of a display pixel 408 and a detection pixel 409. The display pixel 408 is constituted of the display element 11 and the pixel circuit 200. Here, as explained in conjunction with FIG. 17, the data latch switch TFT1 for scanning the display element 11 in the horizontal direction is incorporated in the pixel circuit 200. The detection pixel 409 is constituted of a light-receiving-use element 110 and the pixel detection switch TFT3. The switch 15 is controlled in response to a control signal 21 outputted from the display control part 3-1. The switch 16 is controlled in response to a control signal 22 outputted from the display control part 3-1.

Next, the manner of operation of the panel system shown in FIG. 18 is explained. At the time of display, in response to the control signal 21 and the control signal 22 from the display control part 3-1, the switches 15 are turned on and the switches 16 are turned off. In this state, a gray-scale signal from the display control part 3-1 is supplied to the signal line DATA. Further, in response to the gray-scale signal from the display control part 3-1, the pixel circuit 200 applies a voltage to the display element 11 by controlling a voltage from the display-use voltage source 13, and allows the display pixel 408 to emit light. As described above, by controlling the respective switches, the display pixels emit light sequentially.

FIG. 19 shows the manner of operation of the panel system at the time of performing the detection. At the time of performing the detection, in response to the control signal 21 and the control signal 22 from the display control part 3-1, the switches 15 are turned off and the switches 16 are turned on. The detection-use current source 12 is connected to the detection line 20, and a fixed voltage is generated in the signal line DATA due to the characteristic of the light-receiving-use element 110 and hence, a state of the light-receiving-use element 110 appears in the detection line 20. Here, when the light-receiving-use element 110 emits light, a contrast is lowered and hence, display quality of the panel is lowered. Accordingly, it is necessary to set a current value of the electric current from the detection-use current source 12 to a value which prevents the light emitting element from emitting light. With respect to a constitutional example relating to the detection line and the display element, a constitutional example of the detection circuit 5, detection timing, and a flowchart showing a processing in a display control, the constitutional examples, timing, and the flowchart explained in conjunction with FIG. 8, FIG. 9, FIG. 10 and FIG. 11 respectively are applicable in the same manner.

Here, the detection switch 4 described in the above-explained embodiments can be incorporated in the driver IC.

What is claimed is:

1. An organic EL display device forming a plurality of pixels in a display region, wherein
the pixel includes a signal line, a capacitor, a first switch, a second switch, a power source line, and an organic thin film element,
the organic thin film element includes a pixel electrode which is separated for every pixel, a counter electrode overlapping with the pixel electrode, and an organic layer sandwiched between the pixel electrode and the counter electrode,
a gray-scale signal is supplied to the signal line,
a potential difference corresponding to the gray scale signal is held in the capacitor,
a first switch which controls a quantity of electric current flowing between the power source line and the organic thin film element corresponding to the potential difference held by the capacitance is connected between the power source line and the organic thin film element,
a second switch is connected between the signal line and the power source line, and
the second switch is controlled to connect the signal line and the organic thin film element during a period in which the gray scale signal is not supplied to the signal line.

2. An organic EL display device comprising:
a drive circuit arranged outside a display region and outputting a gray-scale signal;
signal lines extending to the inside of the display region from the outside of the display region;
power source lines extending to the inside of the display region from the outside of the display region; and
a plurality of pixels arranged in the inside of the display region, wherein
the pixel includes a first switch and a second switch constituted of a thin film transistor and an organic thin film element,
the organic thin film element includes a pixel electrode which is separated for every pixel, a counter electrode overlapping with a plurality of pixel electrodes, and an organic layer sandwiched between the pixel electrode and the counter electrode,
the power source line is electrically connected with the organic thin film element via the first switch,
the signal line is electrically connected with a control terminal of the first switch,
the signal line is electrically connected with the organic thin film element via the second switch,
a gray scale signal is supplied to the signal line from the drive circuit during a first period, and
the second switch is turned on and a signal corresponding to an external light from the organic thin film element is supplied to the signal line during a second period different from the first period.

3. An organic EL display device comprising:
light emitting elements; and
light receiving element, wherein
the light emitting element includes a pair of electrodes and an organic layer sandwiched therebetween,
the light receiving element includes a pair of electrodes and an organic layer sandwiched therebetween, and
the organic layer of the light emitting element and the organic layer of the light receiving element differ from each other in the layered structure.

4. An organic EL display device according to claim 5, wherein the organic layer of the light receiving element is a layer which does not emit light with an external light.

5. An organic EL display device according to claim 5, wherein the organic layer of the light receiving element includes a material layer equal to a portion of the organic layer of the light emitting element.

6. An organic EL display device according to claim 5, wherein the light receiving elements are arranged within a display region surrounded by the light emitting elements in a matrix array.

7. An organic EL display device according to claim 5, wherein the light receiving elements are arranged outside an effective display region surrounded by the light emitting elements.

8. An organic EL display device according to claim 5, wherein the organic layer of the light emitting element includes an organic light emitting layer, and
the organic layer of the light receiving element is constituted of only a material layer different from the organic light emitting layer or includes a material layer made of the same material as the organic light emitting layer and having a layer thickness different from a layer thickness of the organic light emitting layer.
